(19) United States
(12) Patent Application Publication
(10) Pub. No.: US 2026/0313325 A1
(43) Pub. Date: Oct. 8, 2026

(54) MISSED CALL ALERTING

(71) Applicant: T-Mobile Innovations LLC, Overland Park, KS (US)

(72) Inventors: Khurram MIRZA, Renton, WA (US); Saqib BADAR, Bellevue, WA (US); Ayman ZAKI, Renton, WA (US)

(21) Appl. No.: 19/173,113

(22) Filed: Apr. 8, 2025

(51) Int. Cl. H04W 4/16

(52) U.S. Cl. CPC H04W 4/16

(57) ABSTRACT

Methods and systems provided herein provide for delivering missed call alerts. Methods include detecting, at a telephony application server (TAS), unavailability of a wireless device. Methods further include recording missed call information related to a missed call to the wireless device, the missed call information including a timestamp and an originating device identifier associated with the missed call to the wireless device. The method further includes detecting availability of the wireless device and delivering the missed call information as a missed call alert to the wireless device upon detecting availability of the wireless device.

### TECHNICAL BACKGROUND

As wireless networks evolve and grow, there are ongoing challenges in communicating data across different types of networks. For example, a wireless network may include one or more access nodes, such as base stations, including, for example, evolved NodeBs (eNodeBs or eNBs) and next generation NodeBs (gNodeBs or gNBs) for providing wireless voice and data service to wireless devices in various coverage areas of the one or more access nodes. As wireless technology continues to improve, various different iterations of radio access technologies (RATs) may be deployed within a single wireless network. Such heterogeneous wireless networks can include newer 5G and millimeter wave (mm-wave) networks, as well as 4G long-term evolution (LTE) access nodes. Newer networks introduce new features as well as new challenges.

Currently, when a wireless device or user equipment (UE) connecting to any of the above-described wireless networks becomes unavailable for various reasons and misses a call that cannot be routed to voicemail, the wireless device does not receive a notification of the missed call. For example, when the wireless device cannot receive a signal due to its location, its settings, e.g., when the wireless device is in airplane mode, or when the wireless device is turned off or has no remaining battery power, no information is provided to the wireless device regarding missed calls. Accordingly, wireless devices are not currently provided with missed call notifications in many situations. Thus, a solution is needed for providing missed call notifications to wireless devices in the above-described situations.

### OVERVIEW

Exemplary embodiments provided herein include a method for providing missed call alerts. The method includes detecting, at a telephony application server (TAS), unavailability of a wireless device and recording missed call information related to a missed call to the unavailable wireless device. The missed call information may include a timestamp and an originating device identifier associated with the missed call to the wireless device. The method further includes detecting availability of the wireless device and delivering the missed call information as a missed call alert to the wireless device upon detecting availability of the wireless device.

In further embodiments, a missed call alert system is provided. The missed call alert system includes a memory storing data and instructions and a processor executing the stored instructions to perform multiple operations. The operations include detecting, at a telephony application server (TAS), unavailability of a wireless device and recording missed call information that may include a timestamp and an originating device identifier associated with a missed call to the unavailable wireless device. The method additionally includes detecting availability of the wireless device and triggering delivery of the missed call information as a missed call alert to the wireless device upon detection of availability of the wireless device.

In a further embodiment, a non-transitory computer-readable medium stores instructions executed by a processor to perform multiple operations. The operations include detecting, at a telephony application server (TAS), unavailability of a wireless device and initiating recording of missed call information including a timestamp and an originating device identifier associated with a missed call to the wireless device. The operations additionally include detecting availability of the wireless device and triggering delivery of the missed call information as a missed call alert to the wireless device upon detecting availability of the wireless device.

Further embodiments include TASs and processing nodes performing the operations described above.

### BRIEF DESCRIPTION OF THE DRAWINGS

FIG. 1 depicts an exemplary environment for missed call alerting in accordance with an embodiment.

FIG. 2 depicts a missed call alerting system in accordance with an embodiment.

FIG. 3 depicts an exemplary operating environment for missed call alerting in accordance with an embodiment.

FIG. 4 depicts a further exemplary operating environment for missed call alerting in accordance with an embodiment.

FIG. 5 depicts a method for missed call alerting in accordance with an embodiment.

FIG. 6 depicts a further exemplary method for missed call alerting in accordance with an embodiment.

FIG. 7 depicts an additional exemplary method for missed call alerting in accordance with an embodiment.

FIG. 8 depicts yet a further exemplary method for missed call alerting in accordance with an embodiment.

### DETAILED DESCRIPTION

In embodiments disclosed herein, methods, systems, and non-transitory computer-readable mediums are provided for missed call alerting. Currently, wireless devices fail to receive missed call notifications in many situations. For example, internet protocol multimedia subsystem (IMS) networks fail to deliver missed call notifications when a call does not reach voicemail. This situation may occur, for example, when a wireless device is out of range and does not receive a signal, when a wireless device is turned off or has no battery power, or when the wireless device is in airplane mode or has activated other settings rendering it unreachable.

Embodiments provided herein utilize components of the IMS and/or a system communicating with the IMS to detect wireless device unavailability to trigger recording of missed call information based on the unavailability. Embodiments provided herein cause the missed call information to be delivered to the wireless device upon detection of availability of the wireless device. For example, the IMS or communicating system triggers the sending of a short messaging service (SMS) text message to the wireless device when availability of the wireless device is detected. The recorded information may be sent in the form of a missed call alert (MCA) and may include, for example, a Mobile Station International Subscriber Directory Number (MSISDN). The MSISDN is a number uniquely identifying a subscription in a Global System for Mobile communications or a Universal Mobile Telecommunications System mobile network. The MSISDN is the mapping of the telephone number to the subscriber identity module in a mobile or cellular phone and is used for routing calls to the wireless device. The MCA may further include a timestamp of each missed call for the wireless device.

In scenarios described herein, systems and methods may trigger recording of missed calls when a wireless device is out of coverage for any of the above-described reasons or other reasons and will deliver a notification, such as a short messaging service (SMS) notification, to the wireless device once it comes back to network coverage and performs a new attach procedure. In this manner, the wireless device will be notified of missed call information via the IMS once the wireless device returns to the network. In embodiments herein, this MCA service will be provided to devices that subscribe to the MCA solution by taking advantage of a subscription option offered through the network provider.

Multiple architectures and methods can be utilized to record and deliver the MCAs to wireless devices. In these architectures, a telephony application server (TAS) of the IMS detects that a wireless device is not reachable for a voice call and triggers the MCA process based on this determination. The MCA process involves detection of unavailability, recording, storage, detection of availability and delivery. The recording and storage processes may be carried out by different components depending on the solution architecture. Ultimately an MCA including, for example, a timestamp and a MSISDN, may be delivered as an SMS message to the wireless device once the wireless device becomes available.

In addition to the systems and methods described herein, non-transitory computer-readable mediums may store the operations or the instructions for performing various methods. Further, processing nodes on the network may execute the instructions or methods. The processing node may include a processor included in the TAS and/or a processor included in any controller node in the wireless network.

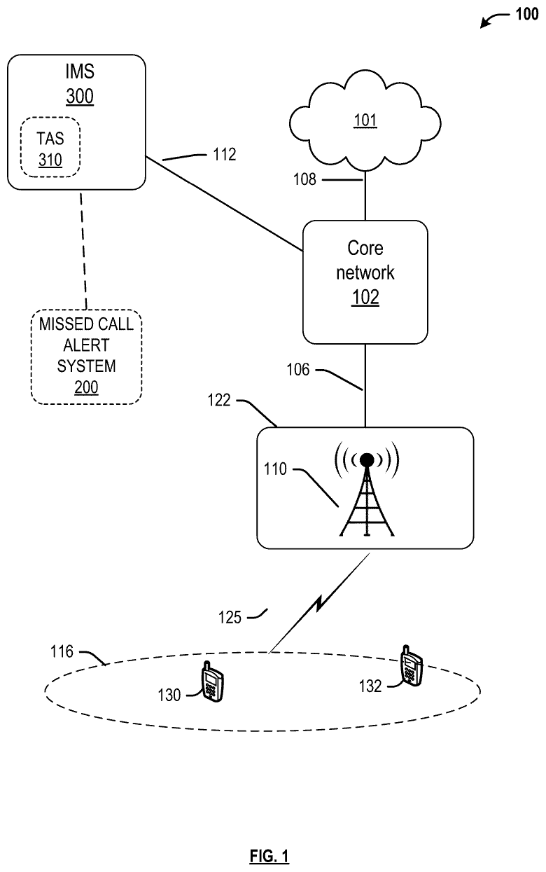

FIG. 1 depicts an exemplary environment 100 for implementing a missed call alert system 200. Environment 100 comprises a communication network 101, core network 102, a radio access network (RAN) 122 including at least an access node 110, and internet protocol (IP) multimedia subsystem (IMS) 300 including at least a telephony application server (TAS) 310 operating in conjunction with the missed call alert system 200. Wireless devices 130 and 132 are located in a coverage area 116 and communicate with the access node 110 over communication link 125. Although only two wireless devices 130, 132 are shown, it should be understood that any number of wireless devices could be included. Further, the missed call alert system 200 is included in or interacts with the IMS 300.

The IMS 300 is an architectural framework for delivering multimedia communications services such as voice, video and text messaging over IP networks. The IMS 300 may include multiple functions and nodes. For example the IMS 300 may include the telephony application server (TAS) 310. The TAS 310 contains service logic that provides basic call-processing services, such as, for example, digit analysis, routing, call setup, call waiting, call forwarding, etc.

The core network 102 may include an SBA architecture, such as for 5G NR systems, in which service-based interfaces may be utilized between control plane functions, while multiple user plane functions connect over point-to-point link. Multiple network functions within the core network 102 may communicate with and subscribe to multiple other network functions. As an alternative, the core network 102 may have an evolved packet core (EPC) architecture, such as for 4G LTE systems.

The missed call alert system 200 is illustrated as communicating with or incorporated in the IMS 300. The missed call alert system 200 may further communicate with or be partially incorporated in other IMS components to be further described herein. The missed call alert system 200 operates, for example, on a call received from wireless device 130 to wireless device 132. The wireless device 132 is illustrated as traveling out of range in FIG. 1. For example, the wireless device 132 may be located where no cell signal is present. However, in other scenarios, the wireless device is in airplane mode, is turned off, has a dead battery, or is otherwise unavailable. Other scenarios are within scope of the disclosure. The missed call alert system 200 operates in these scenarios to ensure that calls originating at wireless device 130 and terminating at wireless device 132 may be recorded and that a missed call alert is delivered to wireless device 132 when the wireless device 132 becomes available. More specifically, the missed call alert system 200 may operate to record and deliver missed call alerts based on availability determinations reported by the TAS 310.

The RAN 122 can include various access network functions and devices disposed between the core network 102 and the end-user wireless devices 130, 132. For example, the RAN 122 includes at least an access node (or base station), such as an eNodeB and/or a next generation NodeB (gNodeB) 110 communicating with the end-user wireless device 130. Further, either of core network 102 and radio access network 122 can include one or more of a local area network, a wide area network, and an internetwork (including the Internet) and be capable of communicating signals and carrying data, for example, to support voice, push-to-talk, broadcast video, and data communications by end-user wireless devices 130, 132.

Access node 110 can be any network node configured to provide communication between end-user wireless devices 130, 132 and communication network 101, including standard access nodes and/or short range, low power, small access nodes. For instance, access node 110 may include any standard access node, such as a macrocell access node, base transceiver station, or a radio base station, or the like. In embodiments further discussed herein, the access node 110 is a next generation NodeB (gNB). However, the access node 110 may include multiple co-located access nodes, such as a combination of eNodeBs and gNodeBs. Access node 110 can be a small access node including a microcell access node, a picocell access node, a femtocell access node, or the like such as a home NodeB or a home eNodeB device. Moreover, it is noted that while access node 110 and wireless devices 130, 132 are illustrated in FIG. 1, any number of access nodes and wireless devices can be implemented within environment 100.

Access node 110 can utilize antennas to deploy a wireless air interface 125 using one or more frequency bands over one or more coverage areas 116. Further, the different sets of antennas can be used to implement various transmission modes or operating modes in each sector, including but not limited to multiple in multiple out (MIMO), carrier aggregation (including inter-band and intra-band carrier aggregation), and different duplexing modes including frequency division duplexing (FDD) and time division duplexing (TDD).

Wireless devices 130, 132 may be any device, system, combination of devices, or other such communication platform capable of communicating wirelessly with access node 110 using one or more frequency bands deployed therefrom. Wireless devices 130, 132 may be, for example, a mobile phone, a wireless phone, a wireless modem, a personal digital assistant (PDA), a voice over internet protocol (VoIP) phone, a voice over packet (VOP) phone, a soft phone, a home internet (HINT) device, a fixed wireless access (FWA) device as well as other types of devices or systems that can exchange audio or data via access node 110. The FWA devices may include, for example, customer premises equipment (CPE). Additionally, wireless devices have evolved to include Internet of things (IoT) devices, which describes the network of physical objects or things that are embedded with sensors, software, and other technologies for the purpose of connecting and exchanging data with other devices and systems over the Internet. The wireless devices 130, 132 can be end-user wireless devices (e.g., user equipment (UEs)) utilizing communication links 125, which may operate based on 6G, 5G new radio (NR), 4G long term evolution (LTE), or any other suitable type of ratio access technology (RAT).

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless device 130. Wireless network protocols can comprise multimedia broadcast multicast services (MBMS), code division multiple access (CDMA) single-Carrier radio transmission technology (1×RTT), Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), and Worldwide Interoperability for Microwave Access (WiMAX), Fourth Generation broadband cellular (4G, LTE Advanced, etc.), Fifth Generation mobile networks or wireless systems (5G, 5G New Radio (“5G NR”), or 5G LTE), and/or other protocols. Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), Asynchronous Transfer Mode (ATM), and/or other protocols. Communication network 101 can also comprise additional base stations, controller nodes, telephony switches, internet routers, network gateways, computer systems, communication links, or some other type of communication equipment, and combinations thereof.

Communication links 106, 108, and 112 can use various communication media, such as air, space, metal, optical fiber, or some other signal propagation path—including combinations thereof. Communication links 106, 108, and 112 can be wired or wireless and use various communication protocols such as Internet, Internet protocol (IP), local-area network (LAN), optical networking, hybrid fiber coax (HFC), telephony, T1, or some other communication format—including combinations, improvements, or variations thereof. Wireless communication links can be a radio frequency, microwave, infrared, or other similar signal, and can use a suitable communication protocol as described herein. Communication links 106, 108, and 112 can be a direct link or might include various equipment, intermediate components, systems, and networks. Communication links 106, 108, and 112 may comprise many different signals sharing the same link.

Other network elements may be present in environment 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between access node 110 and communication network 101.

Further, the methods, systems, devices, networks, network functions, access nodes, and equipment described above may be implemented with, contain, or be executed by one or more computer systems and/or processing nodes. The methods described above may also be stored on a non-transitory computer readable medium. Many of the elements of communication environment 100 may be, comprise, or include computers systems and/or processing nodes.

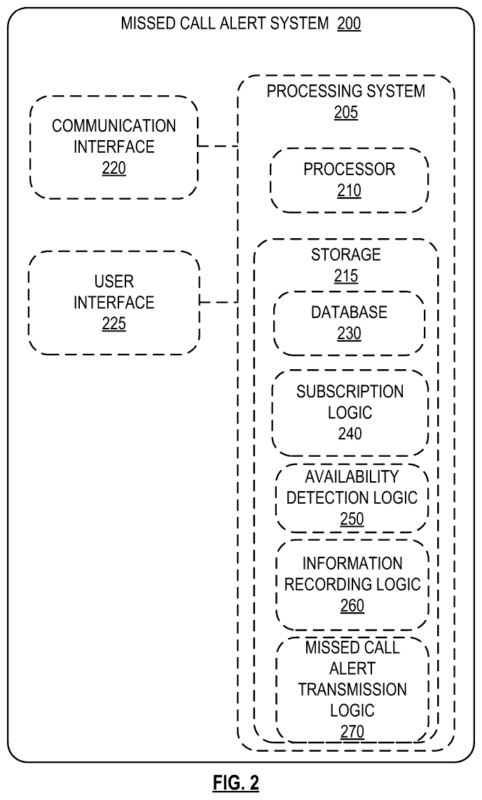

FIG. 2 illustrates a missed call alert system 200 in accordance with embodiments described herein. The components described herein are merely exemplary as many different configurations for the missed call alert system 200 may be implemented. The missed call alert system 200 may be configured to perform the methods and operations disclosed herein to trigger recording and delivery of missed call alerts. For example, the missed call alert system may operate based on detection of unavailability of a called device to recording incoming call information. The incoming call information may include, for example, a time of the incoming call and an indicator of call origin, such as an MSISDN of the calling party. The missed call alert system 200 may compile the recorded information into a missed call alert (MCA) for the unavailable party. Upon making or receiving a determination that the called party has become available, the missed call alert system 200 may cause the MCA to be delivered to the called device, for example, through delivery of an SMS message. In the disclosed embodiments, the missed call alert system 200 may be integrated with the IMS 300, for example with the TAS 310, or may be an entirely separate component capable of communicating with at least the TAS 310 of the IMS 300. Further, the components of the missed call alert system 200 may be distributed so that one or more components are located within the IMS 300 and/or a separate processing node in communication with or integrated with the IMS 300.

The missed call alert system 200 may be configured for performing the operations described herein utilizing a processing system 205. Processing system 205 may include a processor 210 and a storage device 215. Storage device 215 may include a random access memory (RAM), read-only memory (ROM), disk drive, a flash drive, a memory, or other storage device configured to store data and/or computer readable instructions or codes (e.g., software). The computer executable instructions or codes may be accessed and executed by processor 210 to perform various methods disclosed herein. Software stored in storage device 215 may include computer programs, firmware, or other form of machine-readable instructions, including an operating system, utilities, drivers, network interfaces, applications, or other type of software. For example, software stored in storage device 215 may include a module for performing various operations described herein.

For example, subscription logic 240 may be operable wireless device users to subscribe to the missed call alert system 200. Availability detection logic 250 may enable determination of availability of a wireless device, such as, for example, wireless device 130, 132. The determination of availability may be based on wireless device location, settings, or other wireless device status. The availability detection logic 250 may operate in conjunction with the TAS 310 to determine both availability and unavailability of wireless devices. Further, information recording logic 260 may log missed calls to unavailable wireless devices and record caller information along with a timestamp. The information recording logic 260 may further be operable to compile the recorded information into a missed call alert for a wireless device. Finally, missed call alert transmission logic 270 may be operable to trigger transmission of the compiled missed call alerts to the wireless device when the wireless device becomes available. Thus, the missed call alert transmission logic 270 may be operable to interact with the availability detection logic 250 to identify availability of a wireless device having a corresponding stored MCA and to trigger transmission of the missed call alert to the available wireless device. The missed call alert transmission logic 270 may trigger the IMS 300 to push an update to the available wireless device 130, 132. Database 230 may be utilized to store subscription information as well as the maintained missed call alerts. Further, the database 230 may store authorization lists related to missed calls. These authorization lists may further be accessed and stored at the wireless devices 130, 132. The authorization lists may allow each subscriber to designate a list of callers to be notified when the subscriber returns to the network. In this scenario, the missed call alert transmission logic 270 may further alert callers on the authorization when a called party returns to network coverage. To perform the above-described operations, the subscription logic 240, the availability detection logic 250, the information recording logic 260, and the missed call alert transmission logic 270 may be executed by the processor 210 to manage recording and transmission of missed call alerts and further to update the database 230.

Processor 210 may be a microprocessor and may include hardware circuitry and/or embedded codes configured to retrieve and execute software stored in storage device 215. The missed call alert system 200 further includes a communication interface 220 and a user interface 225. Communication interface 220 may be configured to enable the processing system 205 to communicate with other components, nodes, or devices in the wireless network.

Communication interface 220 may include hardware components, such as network communication ports, devices, routers, wires, antenna, transceivers, etc. User interface 225 may be configured to allow a user to provide input to the network aware DND system 200 and receive data or information from other system components. User interface 225 may include hardware components, such as touch screens, buttons, displays, speakers, etc. The missed call alert system 200 may further include other components such as a power management unit, a control interface unit, etc.

The location of the missed call alert system 200 may depend upon the network architecture. As set forth above, the missed call alert system 200 may be located in the IMS 300, in a separate processing node, or in multiple locations. Alternatively, the missed call alert system 200 may be an entirely discrete component. Further, although shown as a single integrated system, the functions of the missed call alert system 200 may be separated and may be disposed in separate locations.

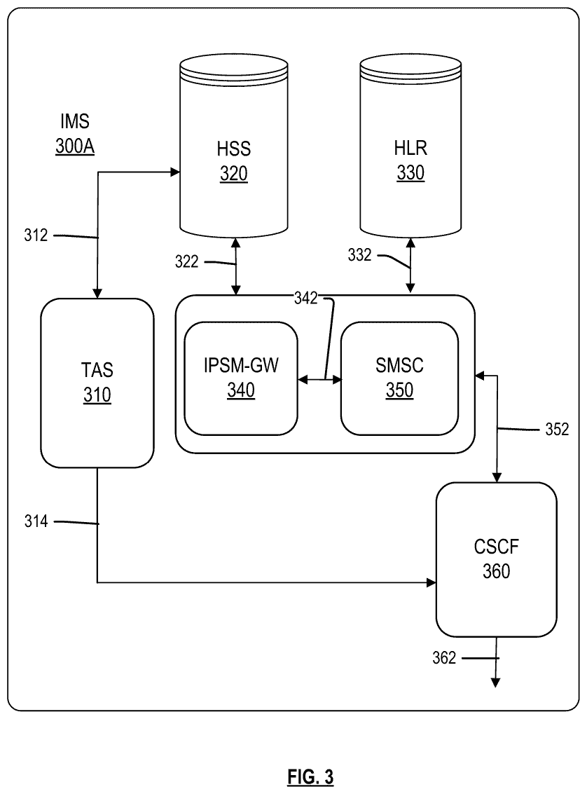

FIG. 3 illustrates an example of an IMS architecture 300A for use with the missed call alert system 200. In the illustrated architecture, a telephony application server (TAS) 310 of the IMS 300A detects that a wireless device is not reachable for a voice call. The TAS 310 initiates the missed call alert (MCA) process by sending information about the calling party to a call session control function (CSCF) 360 over an interface 314. The CSCF 360 may include an interrogating CSCF (I-CSCF) and serving CSCF (S-CSCF) call session control function (I/S CSCF). In operation, the I-CSCF enables requests to be routed to the correct S-CSCF as there may be multiple SCSFs within a network. Further a proxy CSCF (P-CSCF) may be in direct communication with the wireless devices. The TAS 310 also communicates over an interface 312 with a home subscriber server (HSS) 320.

The CSCF 360 communicates over an interface 352 with an internet protocol short messaging gateway (IPSM-GW) 340 that combines all calling party information for a destination device into one message. For example, if a wireless device becomes unavailable and receives multiple calls during the period of unavailability, the IPSM-GW 340 may combine information related to all of these calls into one message in the form of an MCA. Further, the IPSM-GW 340 interacts over an interface 342 with a short message service center (SMSC) 350, which sets a flag in a home location register (HLR) 330 over an interface 332 to indicate that a message is waiting for a particular wireless device. Further, the IPSM-GW 340 may subscribe to the HSS 320 over an interface 322 to receive information about wireless device reachability. The HSS 320 functions as a master user database that supports IMS network entities that handle calls and sessions.

In embodiments provided herein, the IPSM-GW 340 and the SMSC 350 may be collocated in a single component in order to share the reachability information and recorded call information. When the wireless device is reachable, this single component including the SMSC 350 and the IPSM-GW 340 may deliver the consolidated MCA to the wireless device.

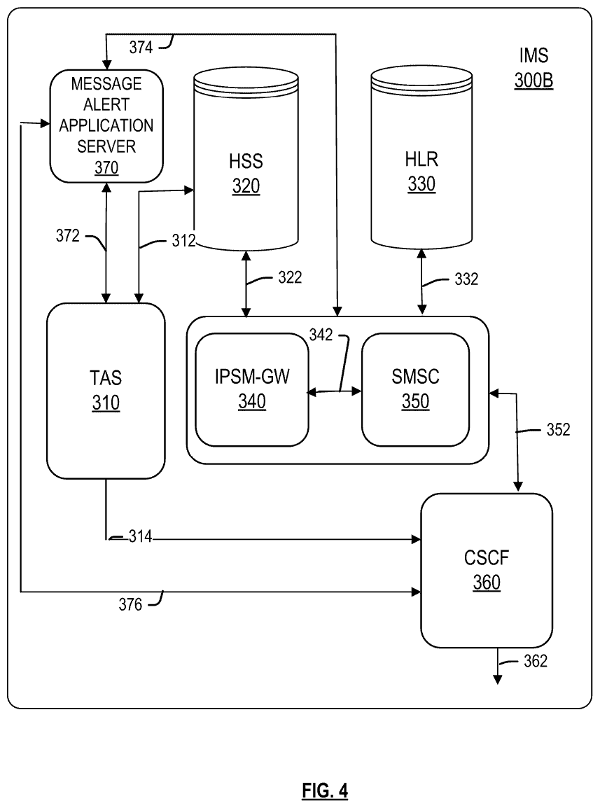

FIG. 4 illustrates a further example of an IMS architecture 300B for use with the missed call alert system 200. Identical reference numbers are used to refer to the same components described above with reference to FIG. 3. In the illustrated architecture of FIG. 4, the telephony application server (TAS) 310 of the IMS 300B detects that a wireless device is not reachable for a voice call. The TAS 310 initiates the missed call alert (MCA) process by sending information about the calling party to the CSCF 360 including the I-CSCF and S-CSCF over an interface 314. Although the CSCF 360 is shown as a consolidated function. In operation, the I-CSCF enables requests to be routed to the correct S-CSCF as there may be multiple SCSFs within a network. The TAS 310 also communicates over an interface 312 with a home subscriber server (HSS) 320 to receive reachability alerts from the HSS 320. Thus, the HSS 320 notifies the TAS 310 when a wireless device becomes reachable.

Further, a message alerting application server (MAAS) 370 interacts over an interface 372 with the TAS 310. The interface 372 incorporates a representational state transfer (REST) application program interface (API). Upon determining unavailability or unreachability as explained herein, the TAS 310 notifies the MAAS 370 using the REST API 372 to record calling party details and timestamps. The MAAS 370 can aggregate the recorded information and initiate alerting via the REST API 372. The MAAS 30 may further interact with the IPSM-GW 340 and the SMSC 350 using an interface 374 and may interact with the CSCF 360 using an interface 376.

Further, because multiple TASs 310 may operate to handle calls, any newly introduced TAS 310 can retrieve alerts from the MAAS 370 and subscribe to the HSS 320 for availability notifications. The previously connected TAS 310 can unsubscribe from both the MAAS 370 and the HSS 320.

The additional illustrated components including the CSCF 360, IPSM-GW 340, SMSC, 350, and HLR 330 may operate substantially as described above with reference to FIG. 3 to deliver the consolidated MCA to the wireless device such as 130, 132, upon notification of availability.

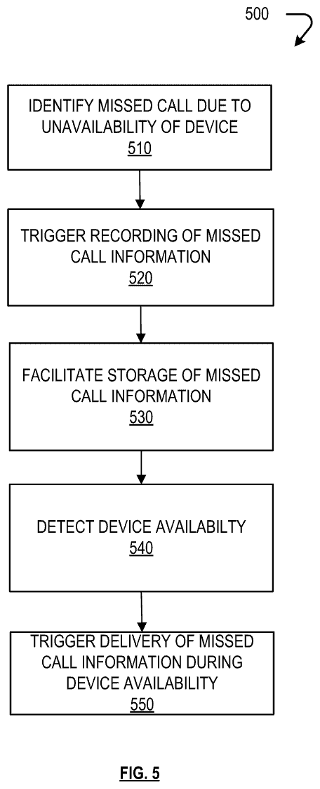

FIG. 5 illustrates a generalized exemplary method 500 for operation of the missed call alert system 200. Method 500 may be performed by a processor, for example, the processor 210 included in the network aware missed call alert system 200, or one or more processors in the IMS 300. For discussion purposes, as an example, method 500 is described as being performed by the processor 210 of the missed call alert system 200. However, it should be understood that the steps illustrated in FIG. 5 are performed in conjunction with the TAS 310 and the processor 210 may, in fact, be incorporated in the TAS 310.

Method 500 starts in step 510, in which the processor 210 identifies a missed call due to unavailability of a device. The situations in which devices are unavailable for the purposes of the missed call alerts may be configurable by a network operator. The situations may include lack of coverage due to being out of range, airplane mode, dead battery, device powered off, or other similar situations. The situations may all result in the inability to deliver a voicemail message to the wireless device. The processor 210 may be in communication with or incorporated in the TAS 310 to detect unavailability of a wireless device to receive an incoming call.

The identification of the wireless device missing a call due to unavailability triggers recording of missed call information in step 520. The missed call information may include, for example, a caller identifier such as MSISDN and a time of the missed call. In step 530, the processor 210 facilitates storage of the missed call information. The recorded information may be compiled and stored in various ways to facilitate delivery of missed call alerts. For example, information pertaining to multiple missed calls to each unavailable wireless device may be collected for that device and stored in the form of an SMS message.

In step 540, the processor 210 detects availability of the previously unavailable wireless device. The wireless device may become available, for example, when its settings are changed or when it travels back within range of a signal. Upon determination that the previously unavailable wireless device is available, the processor 210 triggers delivery of missed call information in the form of a missed call alert (MCA) to the previously unavailable wireless device. As explained above with respect to FIG. 3, the delivery may be accomplished using the IPSM-GW 340 and SMSC 350 to send a text message with the MCA to the previously unavailable wireless device. Further, in step 540, when a list of authorized callers is stored, the processor 210 may trigger a notification to the authorized callers that the called party has traveled back in range. In some embodiments, this notification may be delivered to all callers, for example, when no authorization list is stored.

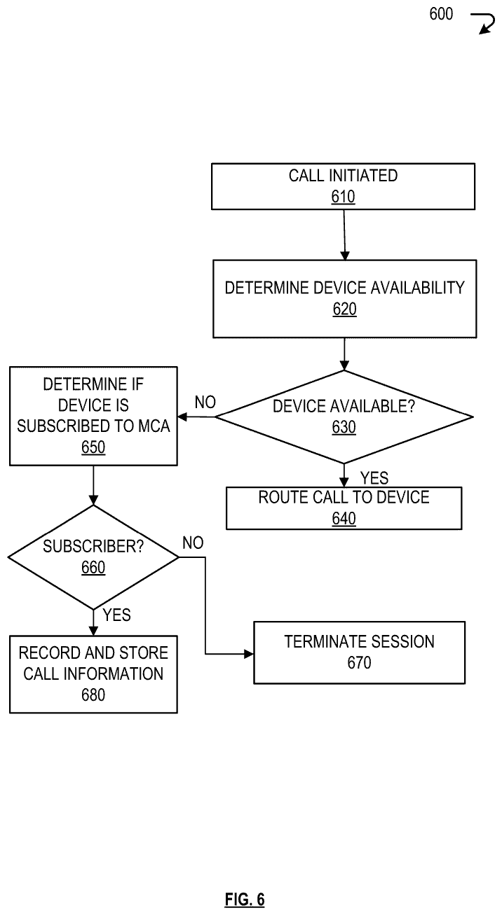

FIG. 6 depicts a further exemplary method 600 for operation of the missed call alert system 200. Method 600 may be performed by any suitable processor discussed herein, for example, the processor 210 included in the missed call alert system 200 or a processor in the TAS 310 or other processor in the IMS 300. For discussion purposes, as an example, method 600 is described as being performed by the processor 210 included in the missed call alert system 200, which may be wholly or partially incorporated in the IMS 300.

Method 600 starts in step 610 when a call is initiated such as a call originating at the wireless device 130 and directed to the wireless device 132. In step 620, the processor 210 determines availability of the wireless device 132. Availability may be determined based on configurable network settings and as set forth herein, may include poor signal quality or no signal, device powered off, dead battery, device settings such as airplane mode, etc. The unavailability scenarios may result in the inability of the wireless device 132 to receive a voicemail message. If the processor 210 determines that the wireless device 132 is available in step 630, the call is routed to the wireless device 132 in step 640 using normal network procedures.

However, if the wireless device 132 is deemed unavailable in step 630, the processor determines if the wireless device 132 subscribes to MCA in step 650. For example, the wireless device 132 may subscribe to MCA by contacting a network service provider via customer care or via short code unstructured supplementary service data (USSD) string. Subscriptions may be stored, for example, in the database 230, in the HSS 320, or at another location within the IMS.

If the processor 210 determines that the wireless device is a subscriber device in step 660, the processor 210 triggers the recording and storing of information in step 680. The information may include, for example, the time of the call and an identification of the caller, such as a mobile station international subscriber directory number (MSISDN). As further set forth herein, this information can be compiled into an MCA and delivered to the wireless device 132. However, if the processor 210 determines that the wireless device 132 is not a subscriber device in step 550, the session is terminated in step 670 using normal network procedures.

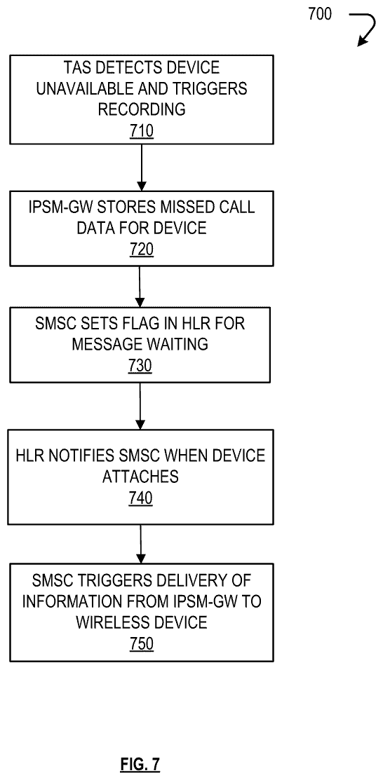

FIG. 7 depicts a further exemplary method 700 for operation of the missed call alert system 200 in accordance with an embodiment. Method 700 may be performed by any suitable processor discussed herein, for example, the processor 210 included in the missed call alert system 200 or processors included in the IMS 300. For discussion purposes, as an example, method 700 is described as being performed by processors contained in various components of the IMS 300, which may wholly or partially incorporate the missed call alert system 200. More specifically, FIG. 7 illustrates a method performed within the IMS architecture 300A of FIG. 3 described above.

Method 700 starts in step 710, when the TAS 310 detects that a called wireless device is unavailable. The TAS 310 triggers, based on the unavailability, the MCA process including recording of call information in order to create an MCA. Based on a notification originating at the TAS 310, the IPSM-GW 340 stores missed call data in step 720 for the called device. In operation, the TAS 310 may send information about the missed call to the CSCF 360, which forwards the information to the IPSM-GW 340 for recording and combining all missed call data for a called device into an MCA. For example, if the unavailable called device receives multiple calls during the period of unavailability, the IPSM-GW 340 may combine information related to all of these calls into one message in the form of an MCA and may store the MCA or direct storage of the MCA in the HSS 320, which functions as a master database.

Once any missed call data is stored by the IPSM-GW 340, the IPSM-GW interacts with the SMSC 350, which sets a flag in step 730 in the home location register 330 to indicate that a message or an MCA is waiting and is pending delivery upon detection of availability of the called device. Accordingly, in step 740, when the called device attaches to the network and thus becomes available, the HLR 330 notifies the SMSC 350. Further, the IPSM-GW 340 may subscribe to the HSS 320 over an interface 322 to receive notification information about wireless device reachability for called wireless devices.

Finally, upon notification of reattachment from the HLR 330, in step 750, the SMSC 350 triggers delivery of the information in the form of an MCA from the IPSM-GW 340. The delivery to the wireless device may be performed by transmitting the MCA from the IPSM-GW 340 through the CSCF 360, which may include or incorporate the functionality of an I-CSCF, P-CSCF, and S-CSCF. In embodiments disclosed herein, the MCA may be deleted from network storage after being transmitted to the called wireless device. It should be noted that prior to recording, the network may receive and process a subscription to the MCA alerts from the called wireless device. Subscription service for MCA may be offered as an option through the network.

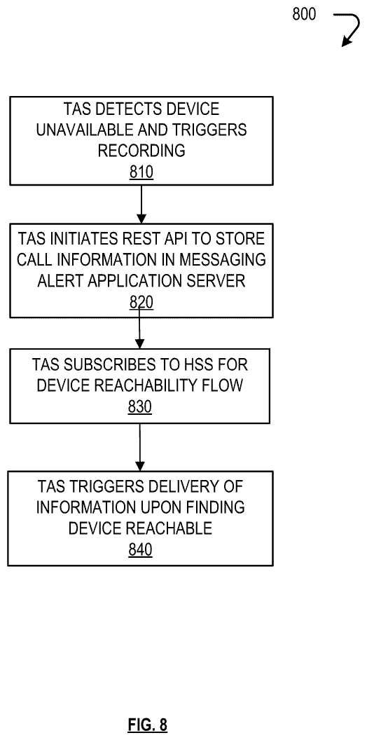

FIG. 8 depicts a further exemplary method 800 for operation of the missed call alert system 200 in accordance with an embodiment. Method 800 may be performed by any suitable processor discussed herein, for example, the processor 210 included in the missed call alert system 200 or processors included in the IMS 300. For discussion purposes, as an example, method 700 is described as being performed by processors contained in various components of the IMS 300, which may wholly or partially incorporate the missed call alert system 200. More specifically, FIG. 8 illustrates a method performed within the IMS architecture 300B of FIG. 4 described above.

Method 800 starts in step 810, when the TAS 310 detects that a called wireless device is unavailable. The TAS 310 triggers, based on the unavailability, the MCA process including recording of call information in order to create an MCA.

In order to record call data, the TAS 310 initiates the REST API 372 to store call information in the MAAS 370. Based on a notification originating at the TAS 310, the MAAS 370 stores missed call data in step 820 for the called device. In operation, the TAS 310 may send information about the missed call to the MAAS 370, which stores the information and combines all missed call data for a called device into an MCA. Thus, the TAS 310 notifies the MAAS 370 using the REST API 372 to record calling party details and timestamps. The MAAS 370 can aggregate the recorded information and initiate alerting via the REST API 372. For example, if the unavailable called device receives multiple calls during the period of unavailability, the MAAS 370 may combine information related to all of these calls into one message in the form of an MCA.

The TAS 310 subscribes to the HSS 320 for device reachability flow in step 830 upon triggering recording. Thus, the TAS 310 communicates over the interface 312 with the HSS 320 to receive reachability alerts from the HSS 320. Thus, the HSS 320 notifies the TAS 310 when a wireless device becomes reachable.

Accordingly, in step 840, when the called device attaches to the network and thus becomes available, the HSS 320 notifies the TAS 310 to trigger delivery of an MCA. The delivery of the MCA to the wireless device can be executed substantially as described above with respect to FIG. 7 with the TAS 310 communicating with the CSCF 360, the IPSM-GW 340 and the SMSC 350.

Further, because multiple TASs 310 may operate to handle calls, any newly introduced TAS 310 can retrieve alerts from the MAAS 370 and subscribe to the HSS 320 for availability notifications. The previously connected TAS 310 can unsubscribe from both the MAAS 370 and the HSS 320.

In embodiments disclosed herein, the MCA may be deleted from network storage after being transmitted to the called wireless device. It should be noted that prior to recording, the network may receive and process a subscription to the MCA alerts from the called wireless device. Subscription service for MCA may be offered as an option through the network.

Accordingly, as set forth above, embodiments provide for calls missed due to unavailability to be recorded and compiled into an MCA for delivery to the called wireless device when the called wireless device becomes available. In some embodiments, methods 500, 600, 700, and 800 may include additional steps or operations. Additionally, the various scenarios may include interactions between additional components, which are omitted for ease of explanation. Furthermore, the methods may include steps shown in each of the other methods. Additionally, the order of steps shown is merely exemplary and the steps may be re-ordered as appropriate. As one of ordinary skill in the art would understand, the methods 500, 600, 700, and 800 may be integrated in any useful manner.

The steps of the methods described above can be combined or rearranged in any meaningful manner. Further, the exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A method comprising:
detecting, at a telephony application server (TAS), unavailability of a wireless device;
recording missed call information related to a missed call to the wireless device, the missed call information including a timestamp and an originating device identifier associated with the missed call to the wireless device;
detecting availability of the wireless device; and
delivering the missed call information as a missed call alert to the wireless device upon detecting availability of the wireless device.

2. The method of claim 1, further comprising triggering the recording upon detection that the wireless device is unavailable to receive the missed call.

3. The method of claim 2, wherein the wireless is unavailable when the wireless device is in airplane mode, is out of range, is out of battery, or is turned off.

4. The method of claim 1, wherein an internet protocol short messaging gateway (IPSM-GW) delivers the missed call information to a call session control function (CSCF) for delivery to the wireless device.

5. The method of claim 1, further comprising providing a subscription option for the wireless device to receive missed call alerts.

6. The method of claim 1, further comprising setting a flag in a home location register (HLR) by a short message service center (SMSC) when the missed call alert has been recorded and is pending delivery.

7. The method of claim 6, wherein the HLR notifies the SMSC when the wireless device becomes available.

8. The method of claim 1, wherein an internet protocol short messaging gateway (IPSM-GW) subscribes to a home subscriber server (HSS) for a wireless device reachability notification.

9. The method of claim 1, wherein a telephony application server (TAS) initiates a representational state transfer (REST) application program interface (API) to store the recorded missed call information as the missed call alert in a messaging alert (MA) application server (AS).

10. The method of claim 9, wherein the TAS subscribes to a home subscriber server (HSS) for a wireless device reachability notification.

11. A system comprising:
a memory storing data and instructions;
a processor executing the stored instructions to perform operations comprising:
detecting, at a telephony application server (TAS), unavailability of a wireless device;
recording missed call information including a timestamp and an originating device identifier associated with a missed call to the wireless device;
detecting availability of the wireless device; and
triggering delivery of the missed call information as a missed call alert to the wireless device upon detecting availability of the wireless device.

12. The system of claim 11, the operations further comprising triggering the recording at the TAS to create a missed call alert upon detection that the wireless device is unavailable to receive an incoming call.

13. The system of claim 12, the operations further comprising setting a flag in a home location register (HLR) by a short message service center (SMSC) when the missed call alert has been recorded and is pending delivery.

14. The system of claim 13, wherein the HLR notifies the SMSC when the wireless device becomes available.

15. The system of claim 11, wherein an internet protocol short messaging gateway (IPSM-GW) subscribes to a home subscriber server (HSS) for a wireless device reachability notification.

16. The system of claim 11, wherein a telephony application server (TAS) initiates a representational state transfer (REST) application program interface (API) to store the recorded missed call information as the missed call alert in a messaging alert (MA) application server (AS).

17. The system of claim 11, wherein the TAS subscribes to a home subscriber server (HSS) for a wireless device reachability notification.

18. A non-transitory computer-readable medium storing instructions executed by a processor to perform operations comprising:
detecting, at a telephony application server (TAS), unavailability of a wireless device
initiating recording of missed call information including a timestamp and an originating device identifier associated with a missed call to the wireless device;
detecting availability of the wireless device; and
triggering delivery of the missed call information as a missed call alert to the wireless device upon detecting availability of the wireless device.

19. The non-transitory computer readable medium of claim 18, wherein initiating recording occurs in response to detection that the wireless device is unavailable to receive an incoming call.

20. The method of claim 2, wherein the wireless device is unavailable when the wireless device is in airplane mode, is out of range, is out of battery, or is turned off.
